(19) United States
(12) Patent Application Publication
(10) Pub. No.: US 2013/0216329 A1
(43) Pub. Date: Aug. 22, 2013

(54) SCREW FASTENER

(71) Applicant: Neville Deutscher, Langwarrin (AU)

(72) Inventor: Neville Deutscher, Langwarrin (AU)

(73) Assignee: IDEAL FASTENERS PTY LTD, Dandenong South, Victoria (AU)

(21) Appl. No.: 13/880,840

(22) PCT Filed: Oct. 14, 2011
(86) PCT No.: PCT/AU11/01311

§ 371 Date: Apr. 22, 2013

(30) Foreign Application Priority Data
Oct. 22, 2010 (AU) 2010904709

(51) Int. Cl. F16B 25/10

(52) U.S. Cl. CPC F16B 25/10
USPC 411/387.2

(57) ABSTRACT

A screw fastener for fastening sheet material to a support, the screw fastener including a shank having an elongate axis, a head at one end of the shank, and a drilling tip at an opposing end thereof, at least one substantially planar wing member extending radially from the shank, the wing member having a peripheral reaming edge, and means for extending the time that the sheet material is in contact with the peripheral reaming edge of the wing member while the screw fastener is being driven through the sheet material

### PRIORITY CLAIM

This patent application is a U.S. National Phase of International Patent Application No. PCT/AU2011/001311, filed 14 Oct. 2011, which claims priority to Australian Patent Application No. 2010904709, filed 22 Oct. 2010, the disclosures of which are incorporated herein by reference in their entirety.

### FIELD

Disclosed embodiments relate to building products, and in particular, to a screw fastener. Disclosed embodiments will be described with respect to fastening non-metallic roofing sheets on to support battens. It is, however, to be understood that the invention is not limited to this application, and can also be used on metal roofing sheets. Other applications are also envisaged.

### BACKGROUND

The material used in the production of non-metallic roofing sheets such as polycarbonate and fibreglass expands and contracts at a different rate and scale to the material of the roof battens upon which they are supported and affixed. These roof battens are normally made from either steel or timber. Therefore, this difference in the expansion and contraction rates must be taken into account when fastening such non-metallic roofing sheets to the roof battens. Otherwise, the roofing sheets will be subjected to cyclic stresses which can eventually lead to cracking and/or crazing of the roofing sheet material as it comes into contact with the shank of the screw fastener. This issue can be addressed by providing a clearance hole having a diameter greater than the diameter of the screw fastener shank in the roofing sheet, with the screw fastener being accommodated within the clearance hole once the roofing sheet is fastened to the support batten.

Significant time savings can be achieved by having the screw fastener form the clearance hole in the roofing sheet at the same time as the screw fastener is being driven through the roofing sheet into the roof batten. Screw fasteners have been developed that can produce a hole within a non-metallic roofing sheet wider than the shank of the screw fastener as it is driven through the roofing sheet. One such screw fastener design uses a pair of opposing, radially extending and substantially planar wing members provided on the shank of the screw fastener to produce a clearance hole. The peripheral edge of each wing member can act together to ream a clearance hole through the roofing sheet as the screw fastener is driven through that sheet material into the support batten. Such screw fasteners are most suitable for use with roofing sheets made from relatively rigid material such as fibreglass. This is because there is minimal deflection of the roofing sheet material as the screw fastener is driven though the roofing sheets into the roof batten. Therefore, the wing members contact the roofing sheet for a period sufficient to allow a clearance hole to be properly reamed by the wing members in the roofing sheet.

These screw fasteners are however less satisfactory for use for the fastening of roofing sheets made of material such as polycarbonate. This is because the polycarbonate roofing sheets are relatively flexible when compared to fibreglass sheets and provide less resistance to the forward movement of the wing members as the screw fastener is driven though the roofing sheet. Therefore, when a screw fastener with wing members is driven into a polycarbonate roofing sheet, the roofing sheet tends to be initially displaced towards the roof batten by the pressure of the drill tip against the roofing sheet following penetration of the drill tip, the threaded portion of the fastener engages the roofing sheet which then runs up the threaded portion to bring the roofing sheet into contact with the wing members. Finally the sheet material in contact with the wing members deforms to an extent sufficient to allow the wing members to pass though the roofing sheet, with the roofing sheet then springing back to it's initial position away from the roof batten. As roofing sheet provides minimal resistance to the forward movement of the wing members, the reaming edges of the wing members have minimal contact with the roofing sheet and cannot properly ream a clearance hole. The resultant hole that is formed is undersized and non-uniform in shape and can have ragged edges due the action of the wing members deforming and forcing their way through the roofing sheet material. Such a non-uniform hole provides little to no clearance between the shank of the fastener and the roofing sheet potentially leading to cracking and/or crazing of the roofing sheet as previously discussed.

It would therefore be advantageous to be able to provide a screw fastener that can produce a larger more effective clearance hole in roof sheets formed from relatively flexible material such as polycarbonate and/or more rigid material such as aluminium or steel.

With this in mind, the disclosed embodiments provide a screw fastener for fastening sheet material to a support, the screw fastener including a shank having an elongate axis, a head at one end of the shank, and a drilling tip at an opposing end thereof, at least one substantially planar wing member extending radially from the shank, the wing member having a peripheral reaming edge, and means for extending the time that the sheet material is in contact with the peripheral reaming edge of the wing member while the screw fastener is being driven through the sheet material.

### BRIEF DESCRIPTION OF THE DRAWINGS

At least one disclosed embodiments will now be described with respect to the accompanying drawings. Other embodiments are possible, and consequently, the particularity of the accompanying drawings is not to be understood as superseding the generality of the description of the disclosed embodiments.

In the drawings:

FIG. 1 is a side view of a screw fastener;

FIG. 2 is another side view of the screw fastener of FIG. 1 rotated 90° about its elongate axis thereof;

FIG. 3 is an end view of the screw fastener of FIG. 1;

FIG. 4 is a side view of another disclosed embodiment of the screw fastener; and

FIG. 5 is a side view of another disclosed embodiment of the screw fastener.

### DETAILED DESCRIPTION OF THE DISCLOSED EMBODIMENTS

The term “drilling tip” encompasses all types of drilling, tapping, piercing and multi-purpose screw fastener points.

The screw fastener may be provided with a pair of the wing members. The wing members may be located in an opposed relation to each other. It is also envisaged that the wing members may be located in a non-opposed relation to each other. The wing members may be aligned generally parallel to the elongate axis of the shank.

The wing members may be located adjacent to and spaced from the head to provide clearance for a resilient washer or the like. The plane of each wing member may be aligned generally parallel to the elongate axis of the shank. The means for extending the time that the sheet material may be in contact with the peripheral reaming edge of the wing member optionally includes at least a substantial portion of the peripheral reaming edge being located at a maximum radial extent of the or each wing member. The peripheral reaming edge is therefore able to be in contact with the sheet material for a longer period. Optionally the peripheral reaming edge at the maximum radial extent extends generally parallel to the elongate axis of the shank. Optionally a portion of the peripheral reaming edge may also be inclined at an angle relative to the elongate axis thereof towards the drilling tip of the screw fastener to thereby provide a lead-in to the parallel reaming edges. It is also envisaged that all portions of the peripheral edge may be inclined relative to the elongate axis thereof.

Optionally, the means for extending the time that the sheet material is in contact with the peripheral reaming edge further or alternatively includes an abutment member located at or adjacent the peripheral reaming edge of the or each wing member.

The abutment member may have a radial extent greater than the radial extent of the wing member. Optionally a respective the abutment member may extend from each the wing member. The abutment member may be located at an end of the wing member adjacent to the head of the screw fastener. The abutment member may be integrally as part of the wing member. It is also envisaged that the abutment member may be separately formed from the wing member. The abutment member may provide a shoulder for engaging the sheet material when the wing members are in contact with the sheet material, the shoulder may extend at right angles relative to the elongate axis of the shank.

As mentioned previously, roofing sheets made from flexible material such as polycarbonate will tend to be displaced by the drill tip pushing the sheet material until such times as the drill drip penetrates, and the sheet material runs up the screw thread and comes in contact with the wing members. The sheet material then deforms to an extent sufficient to allow the wing members to commence passing through the sheet material. At this time, the peripheral reaming edges of the wing members come in contact with the material of the roofing sheet.

The provision of a substantial portion of the peripheral reaming edge of the wing members at the maximum radial extent helps to extend the period of time at which the sheet material is in contact with the reaming edges.

The abutment member of the disclosed embodiments can also assist in retaining the contact of the roofing sheet material against the peripheral reaming edges of the wing members for a period of time to help to ensure that a larger more effective clearance hole is formed in the sheet material. The wing members will eventually also pass their way completely through the roofing sheet as the material of the roofing sheet deforms enough to also allow the abutment members to pass therethrough.

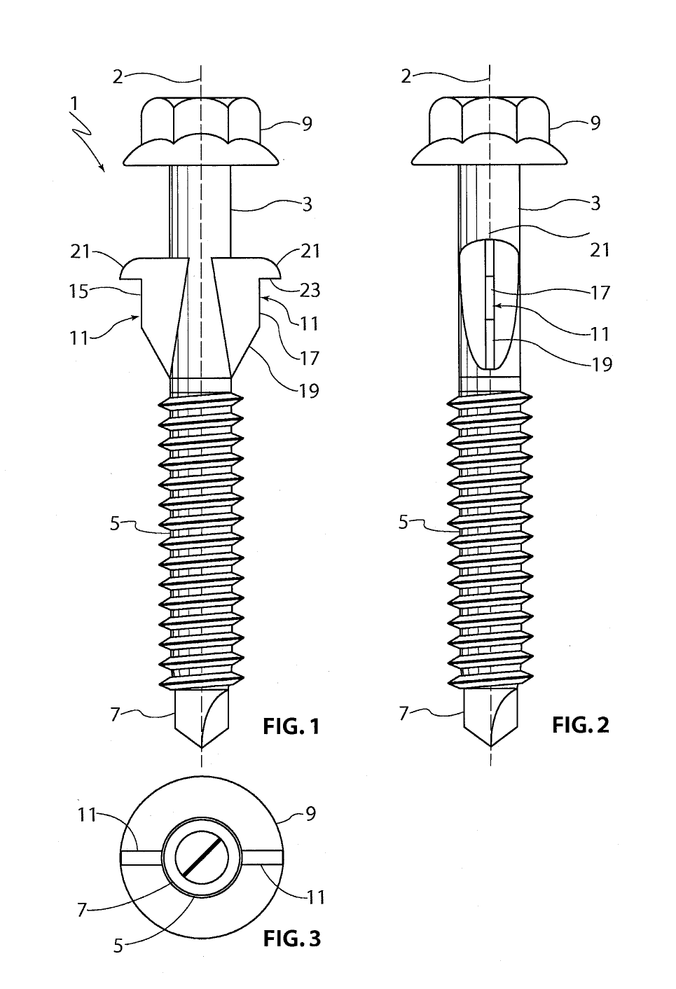

Referring initially to FIGS. 1 to 3, the screw fastener 1 according to at least one disclosed embodiment includes a shank 3 having a threaded portion 5 terminating in a drilling tip 7. A head 9 is provided at the opposing end of the shank 3, the head 9 being used to drive the fastener 1 in a manner well known in the art.

A pair of opposing wing members 11 extends radially from the shank 3, the wing members 11 being located between the head 9 and the threaded portion 5 of the shank. The wing members 11 are spaced from the head 9 to thereby provide clearance for the location of a resilient washer (not shown) on the shank 3.

As shown more clearly in FIGS. 2 and 3, the wing members 11 are substantially planar in configuration and extend parallel to the elongate axis 2 of the shank 3. Each wing member has a peripheral reaming edge 15, with a first portion 17 of the peripheral reaming edge 15 of the wing member 11 extending generally parallel to the elongate axis 2 of the shank. Another portion 19 of the peripheral reaming edge 15 of each wing member 11 is inclined at an angle to the elongate axis 2 of the shank 3. The inclined portion 19 of the peripheral reaming edges 15 act as a “lead in” for the roofing sheet to the parallel portions 17 of the peripheral reaming edge 15 where a substantial part of the reaming can occur.

An abutment member 21 is provided adjacent the generally parallel peripheral reaming edge 17 of each wing member 11. The radial extent of the abutment member 21 is greater than the radial extent of the wing member 11 such that the abutment member 21 provides a shoulder 23 adjacent the generally parallel peripheral reaming edges 17 of the wing member 11.

The wing members 11 can be integrally formed together with the rest of the screw fastener 1. The drilling tip 7 is a SDS drill point which is a multi-purpose type adapted for drilling into steel or other metal material or into timber. The fastener 1 is therefore particularly suited to the fastening of, for example polycarbonate roof sheets to steel or timber roof battens. The fastener 1 can also be used to secure metal roofing sheets onto roof battens, and can be driven through both a non-metallic and metal roofing sheet at the same time when they are in an overlapping arrangement.

When fastening a polycarbonate roofing sheet on to a roof batten, the drilling tip 7 initially drills a hole through the roofing sheet the shank threaded portion 5 then passes through the roofing sheet until the wing members 11 contact the roof sheet. As the screw fastener continues to be driven into the roof batten, the wing members 11 initially engage and displace the roof sheet in a direction towards the roof battens. Increased resistance from the roof sheet as the wing members 11 move closer to the roof batten forces the wing members 11 partially through the material of the roof sheets such that the peripheral reaming edges 15 of the wing members 11 contact the roof sheet material. The abutment members 21 abuts the roofing sheet as the wing members 11 are driven therethrough so that the roofing sheet is now in contact with the generally parallel peripheral reaming edges 17 for a period of time. This helps to ensure that a larger more effective clearance hole is reamed by the peripheral reaming edges 15.

As the screw fastener is driven into its final position, the roofing sheet can eventually jump over the abutment member 21 to its final position between the wing members and the resilient washer (not shown).

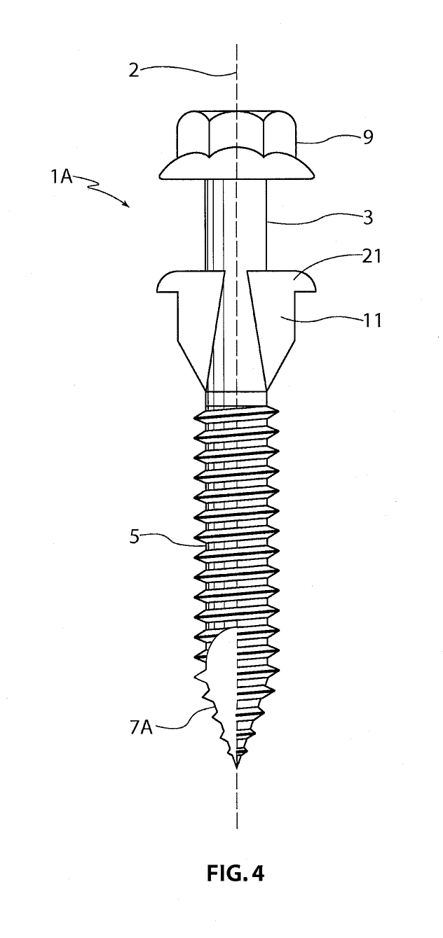

The screw fastener 1A shown in FIG. 4 shares most of the features of the screw fastener shown in FIGS. 1 to 3 and the same reference numerals are used for comparable features. The primary difference is that the drill tip 7A is a type 17 drill point suitable for drilling into timber and thin metal battens. This disclosed screw fastener embodiment otherwise operates in the same manner as the screw fastener shown in FIGS. 1 to 3.

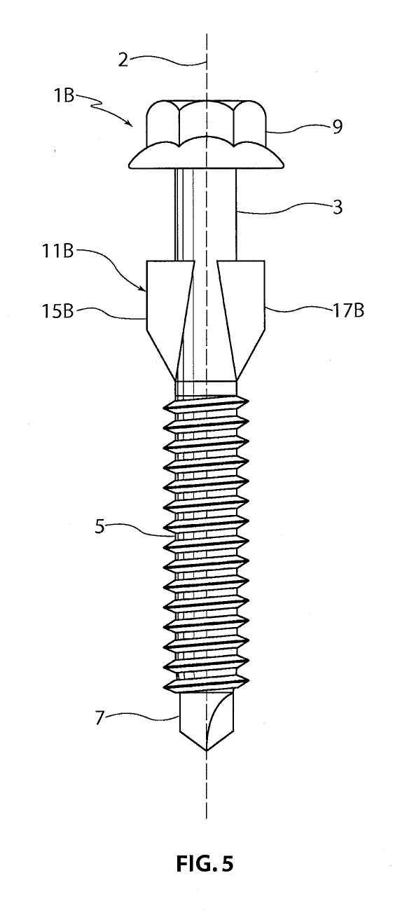

The disclosed screw fastener 1B embodiment shown in FIG. 5 also shares most of the features of the screw fastener shown in FIGS. 1 to 3 and the same reference numerals are used for comparable features. The screw fastener 1B however differs from the previously disclosed embodiments in that the wing members 11B do not have abutment members. This screw fastener therefore relies on a substantial portion of the peripheral edge 15B of each wing member 11B being located at the maximum radial extent of the wing members 11B to extend the period of time at which the sheet material is in contact with the reaming edges. The portion 17B of the peripheral reaming edge 15B located at the maximum radial extent of the wing member 11B extends generally parallel to the elongate axis 2 of the shank 3.

The screw fastener according to the disclosed embodiments allow the production of a larger more effective clearance hole in polycarbonate roofing sheets than would be possible with known screw fasteners using reaming wing members to produce such a hole.

Modifications and variations as would be deemed obvious to the person skilled in the art are included within the ambit of the present invention as claimed in the appended claims.

1. A screw fastener for fastening sheet material to a support, the screw fastener comprising:
a shank having an elongate axis;
a head at one end of the shank;
a drilling tip at an opposing end of the shank
at least one substantially planar wing member extending radially from the shank, the wing member having a peripheral reaming edge; and
means for extending the time that the sheet material is in contact with the peripheral reaming edge of the wing member while the screw fastener is being driven through the sheet material.

2. The screw fastener of claim 1, wherein a pair of the wing members are provided.

3. The screw fastener of claim 2, wherein the wing members are located in an opposed relation to each other.

4. The screw fastener of claim 1, wherein the at least one substantially planar wing member is aligned generally parallel to the elongate axis of the shank.

5. The screw fastener of claim 1, wherein said means includes at least a substantial portion of the peripheral reaming edge the at least one substantially planar wing member being located at a maximum radial extent of the wing member.

6. The screw fastener of claim 5, wherein the peripheral reaming edge at the maximum radial extent extends generally parallel to the elongate axis of the shank.

7. The screw fastener of claim 1, wherein at least a portion of the peripheral reaming edge is inclined at an angle to the elongate axis toward the drilling tip thereof.

8. The screw fastener of claim 1, wherein the at least one substantially planar wing member is located adjacent to and spaced from the head to provide clearance for a resilient washer or the like.

9. The screw fastener of claim 1, wherein the means includes an abutment member located at or adjacent the peripheral reaming edge of the at least one wing member, the abutment member having a radial extent greater than the radial extent of the wing member to thereby provide a shoulder for engaging the roof material.

10. The screw fastener of claim 9, wherein the shoulder extends at right angles relative to the elongate axis of the shank.

11. The screw fastener of claim 9, wherein the abutment member is located at an end of the wing member adjacent the head of the fastener.

12. The screw fastener claim 9, wherein the abutment member is integrally formed as part of the at least one wing member.

13. The screw fastener of claim 9, wherein the abutment member is separately formed from the at least one wing member.

14. The screw fastener of claim 1, wherein the drill tip is an SDS drill point.

15. The screw fastener of claim 1, wherein the drill tip is a Type 17 drill point.

16. The screw fastener of claim 1, wherein the drill tip is a multi-purpose drill point.
